(19) United States
(12) Patent Application Publication
(10) Pub. No.: US 2022/0154490 A1
(43) Pub. Date: May 19, 2022

(54) Unlocking device and door lock

(71) Applicants: Li Zheng, San Francisco, CA (US); Pin Genie Inc., San Francisco, CA (US)

(72) Inventor: Li Zheng, San Francisco, CA (US)

(21) Appl. No.: 17/174,889

(22) Filed: Feb. 12, 2021

Related U.S. Application Data
(60) Provisional application No. 63/115,282, filed on Nov. 18, 2020.

(51) Int. Cl. E05B 47/00; E05B 1/00; G07C 9/25

(52) U.S. Cl. CPC E05B 47/0012; E05B 1/0053; G07C 9/25; E05Y 2400/86; E05B 2047/0094; E05Y 2201/68; E05Y 2400/664; E05B 2047/0016

(57) ABSTRACT

An unlocking device and a door lock are disclosed. The unlocking device includes a signal generating module configured to generate an unlock signal and a control module. The control module comprises a main control unit communicated with the signal generation module, and a drive unit connected with the mechanical lock body. The main control unit is configured to receive the unlocking signal generated by the signal generating module, and control the drive unit to drive the mechanical lock body to unlock according to the unlocking signal received.

### CROSS-REFERENCE TO RELATED APPLICATION

The present application is based on and claims priority to US Provisional Patent Application No. 63/115,282, filed on Nov. 18, 2020. The disclosures of the US Provisional patent application are hereby incorporated by reference in their entireties.

### TECHNICAL FIELD

The present disclosure relates to the technical field of locking devise, and more specifically to an unlocking device and a door lock.

### BACKGROUND

A mechanical door lock is a common device used to lock a door to an external structure. With the continued development of intelligent control technologies, a type of intelligently controlled door locks, which unlock the door lock upon receive of a control signal, have emerged in market. However, for a current intelligent control door lock, a control device is usually integrated into a lock body of the door lock. If a user wants to realize an intelligent unlocking function on the basis of the original mechanical door lock, the user needs to remove the whole original mechanical door lock, and replace it with an intelligent control door lock. Such a replacement of door lock brings high costs, and the replaced mechanical door lock cannot be used continuously, causing wastes.

### SUMMARY

According to several aspects of the present disclosure, there are provided an unlocking device for controlling unlocking of a mechanical lock body, and a door lock.

According to one aspect of the present disclosure, in an embodiment, an unlocking device for controlling unlocking of a mechanical lock body comprises: a signal generating module, configured to generate an unlock signal; and a control module, comprising: a main control unit, communicated with the signal generation module, and a drive unit, connected with the mechanical lock body; wherein, the main control unit is configured to receive the unlocking signal generated by the signal generating module, and control the drive unit to drive the mechanical lock body to unlock according to the unlocking signal received.

In an embodiment, the drive unit comprises: a rotating drive structure, and a rotating shaft, at one end thereof connected to a bolt control member of the mechanical lock body, wherein the rotation driving structure is constructed to drive the rotation shaft to rotate, thereby driving the mechanical lock body to unlock.

In an embodiment, the rotating shaft is provided with a knob structure at another end thereof, and the knob structure is constructed to drive the rotating shaft to rotate while the knob structure is rotated.

In an embodiment, the rotating drive structure comprises a motor and a gear assembly, and the rotating shaft is provided with a gear portion, wherein the motor is in transmission connection with the gear portion by the gear assembly, for driving the rotation shaft to rotate.

In an embodiment, the rotating shaft is provided with a connecting portion at one end thereof, through which the rotating shaft is connected to the bolt control member of the mechanical lock.

In an embodiment, the rotating shaft and the connecting portion are integrally formed.

In an embodiment, the connecting portion is detachably connected to the rotating shaft.

In an embodiment, the unlocking device further comprises a mounting structure, on which the signal generating module is fixedly arranged.

In an embodiment, the mounting structure is provided with a mounting portion formed in a ring shape, for fixedly mounting the installation structure on a door handle.

In an embodiment, the mounting structure comprises a fixing portion connected to the mounting portion, and the signal generating module is arranged on the fixed part.

In an embodiment, the signal generating module comprises at least one of: a fingerprint input unit, a keyboard input unit, an iris recognition unit, a vein recognition unit, a face recognition unit, a radio frequency identification unit, a NFC identification unit, a IC card identification unit, a magnetic card identification unit, a Bluetooth unlock signal identification unit, and a remote network unlock signal identification unit.

In an embodiment, a communication connection between the signal generating module and the main control unit is through one of: the signal generating module and the main control unit are in communication connection through a signal line; and the signal generating module and the main control unit are respectively provided with a wireless signal transceiver, and the wireless signal transceivers are communicatively connected.

In an embodiment, the drive unit comprises: a linear drive structure, and a transmission member, at one end thereof connected to the bolt control member of the mechanical lock body, wherein the linear drive structure is configured to drive the transmission member to move, thereby driving the mechanical lock body to unlock.

According to another aspect of the present disclosure, in an embodiment, a door lock comprises: a mechanical lock body; an unlocking device according to one of above embodiments, wherein the control module of the unlocking device is arranged on one side of the mechanical lock body, and the signal module of the unlocking device is arranged on another side of the mechanical lock body; and a door handle, arranged on the same side as the signal generating module, wherein a lock body driving member on the door handle is connected to the corresponding bolt control member of the mechanical lock body, and the door handle drives a bolt of the mechanical lock body to perform a telescopic movement when the door handle is rotated.

### BRIEF DESCRIPTION OF THE DRAWINGS

The above and/or additional aspects and advantages of the present disclosure will become obvious and easy to understand from the description of the embodiments in conjunction with the following drawings, in the drawings:

FIG. 1 is a schematic diagram of a door lock according to an embodiment of the present disclosure;

FIG. 2 is a block diagram of a door lock according to an embodiment of the present disclosure;

FIG. 3 is an exploded view of a door lock of an embodiment of the present disclosure;

FIG. 4 is a schematic diagram of an unlocking device according to an embodiment of the present disclosure; and

FIG. 5 is a schematic diagram of an unlocking device according to an embodiment of the present disclosure after assembly.

### DETAILED DESCRIPTION

The following describes in detail embodiments of the present disclosure, examples of which are shown in the accompanying drawings, wherein identical or similar reference numerals denote identical or similar elements or elements having the same or similar functions. The embodiments described below by reference to the accompanying drawings are exemplary and are intended only to explain the present disclosure and are not to be construed as limiting the present disclosure.

In the description of the present disclosure, it is to be understood that the orientation or positional relationship in the description, for example, the orientation or positional relationship indicated by the upper, lower, front, rear, left, right, etc. is based on the orientation or positional relationship shown in the accompanying drawings, only for the purpose of facilitating the description of the present disclosure and simplifying the description, and not the device or element indicated or implied must have a particular orientation, be constructed and operated in a particular orientation, and therefore cannot be understood as a limitation on the present disclosure.

In the description of the present disclosure, the “several” means one or more, and “a plurality of” means two or more; “greater than”, “less than”, or “more than” shall be understood to exclude the number per se; “above”, “below” and “within” shall be understood to include the number per se; “first” and “second” is described for the purpose of distinguishing the technical features only, it shall not be understood to indicate or imply relative importance or to implicitly indicate the number of technical features indicated or to implicitly indicate the order of the technical features indicated.

In the description of the present disclosure, unless otherwise expressly limited, words such as setup, installation and connection shall be understood broadly. Those skilled in the art may reasonably determine the specific meaning of the above words in the present disclosure with reference to the content of the embodiments.

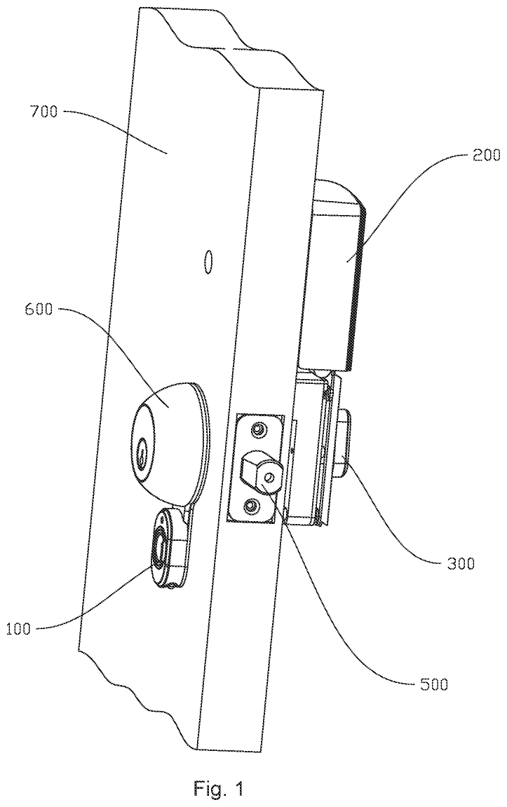

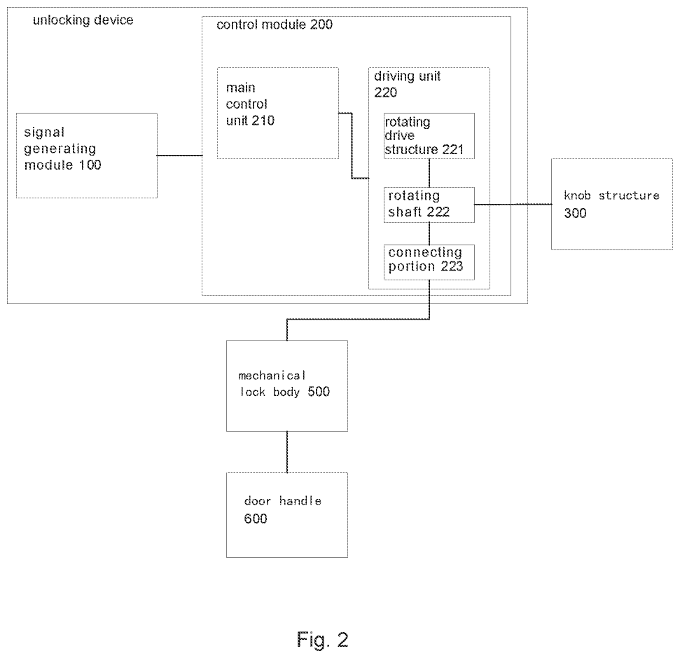

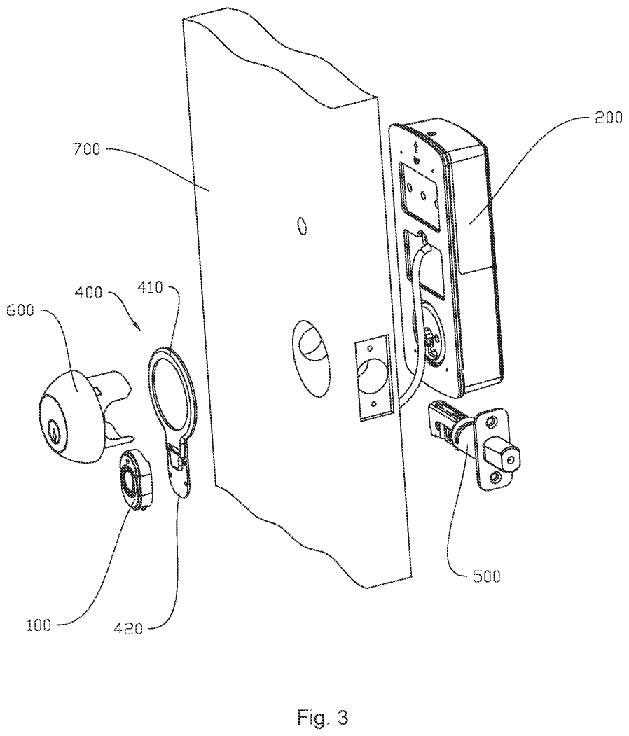

Referring to FIGS. 1, 2 and 3, according to an embodiment of the present disclosure a door lock is comprises a mechanical lock body 500, an unlocking device and a door handle 600, wherein a control module 200 in the unlocking device is arranged on a side of a door 700 close to the interior of a room, the door handle 600 and the signal generating module 100 are arranged on a side of the door 700 away from the interior of the room. The unlocking device is used to control an unlocking process of the mechanical lock body 500 according to a generated signal. A lock body driving member on the door handle 600 is connected to a corresponding bolt control member of the mechanical lock body 500, and the door handle 600 is used to drive a bolt of the mechanical lock body 500 to make a telescopic movement when the door handle 600 is rotated. It is understood that, the mechanical lock body 500 of the embodiment of the present disclosure can be used to control the bolt to make a telescopic movement by rotating the bolt control member, thereby achieving the effect of opening or closing the door. The unlocking device can be powered from an external power source through a wire, or it can be powered by a battery installed.

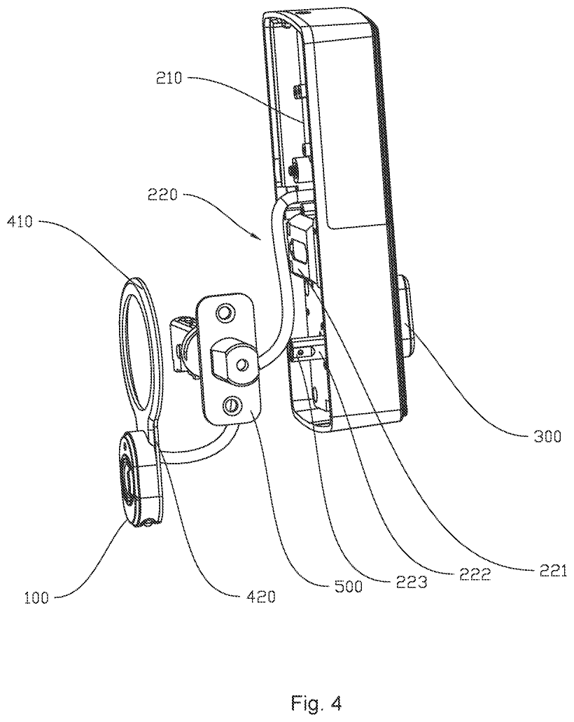

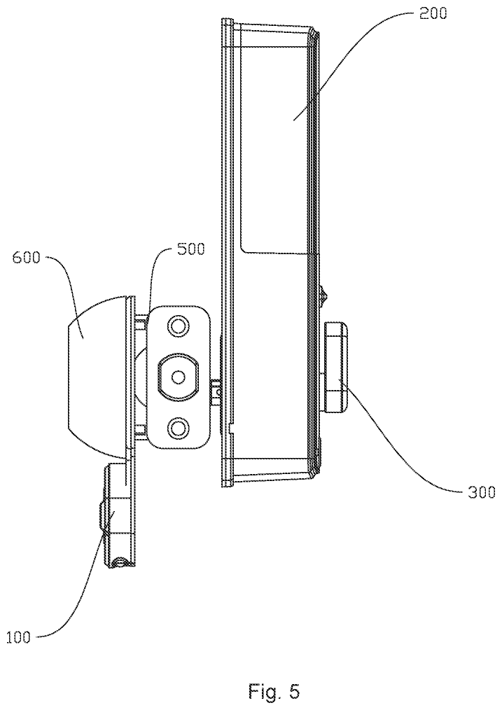

Referring to FIGS. 4 and 5, it can be understood that, the unlocking device includes: a signal generating module 100 for generating an unlocking signal; and a control module 200. The control module 200 includes a main control unit 210 and a driving unit 220, the main control unit 210 is communicated with the signal generating module 100. The driving unit 220 is connected to the mechanical lock body 500. The main control unit 210 is configured to receive the unlocking signal generated by the signal generating module 100 and control the driving unit 220 to drive the mechanical lock body 500 to unlock according to the unlocking signal received. The unlocking device can also be set to automatically lock in a period after unlocking.

An unlocking device is attached to an original mechanical lock. The unlocking device includes a signal generating module 100 and a control module 200, and the control module 200 includes a main control unit 210 and a driving unit 220. The signal generating module 100 is configured to generate an unlocking signal, the driving unit 220 is connected to the mechanical lock body 500, and the main control unit 210 is configured to receive the unlocking signal generated by the signal generating module 100, and control the driving unit 220 to drive the mechanical lock body 500 to unlock according to the unlocking signal received. With the above arrangement, it is possible to directly attach a signal-controlled unlocking device onto the mechanical lock without disassembling the mechanical door lock, thereby effectively reducing the cost of switching from a mechanical door lock to a signal-controlled door lock, and the original mechanical lock body 500 can be continuedly used, this also reduces the waste of door lock materials.

It can be understood that, the driving unit 220 includes a rotating drive structure 221 and a rotating shaft 222. the rotating shaft 222 is provided with on one end thereof a connecting portion 223 matching the bolt control member of the mechanical lock, and the connecting portion 223 is connected to the bolt control member of the mechanical lock. The rotation driving structure 221 is constructed to drive the rotation shaft 222 to rotate to drive the mechanical lock body 500 to unlock. The rotating drive structure 221 includes a motor and a gear assembly. The rotating shaft 222 is provided with a gear portion. An output shaft of the motor is connected to a gear in the gear assembly close to it. The gear portion meshes with a gear in the gear assembly close to it. The function of the rotating drive structure 221 is to make the rotating shaft 222 rotatable, the rotating drive structure 221 may be the motor and gear assembly as described above, which in combination with the gear portion on the rotating shaft 222 allow the rotating function of the rotating shaft 222. This structure is conducive to overall miniaturization. It can be understood that, the rotation driving structure 221 may also be a gear chain structure or a screw structure. The gear portion may be arranged at a middle position or at both ends of the rotating shaft 222. The connecting portion 223 may be a shaft hole or a hole sleeve. In a specific embodiment, it may be matched and set according to the bolt control member of the mechanical lock body 500. In some embodiments, the rotating shaft 222 and the connecting portion 223 are integrally formed.

It can be understood that, the connecting portion 223 and the rotating shaft 222 may be detachably connected. Since different mechanical lock bodies 500 may have different bolt control members, the connecting portion 223 and the rotating shaft 222 are constructed to be detachably connected. When the unlocking device is attached to the mechanical door lock, for different types of the mechanical lock body 500, adaptation can be achieved by only replacing the connecting portion 223, thereby effectively improving the compatibility of the unlocking device of the embodiment of the present disclosure.

It can be understood that, a knob structure 300 is provided at another end of the rotating shaft 222, and a knob structure 300 is configured to drive the rotating shaft 222 to rotate when rotating. By adding the knob structure 300, the mechanical lock body 500 can also be manually opened for open the door within the room.

It is understandable that, the drive unit 220 can also be consisted of a linear drive structure and a transmission member. One end of the transmission member is connected to the bolt control member of the mechanical lock body 500, and the linear drive structure is configured to drive the transmission member to move to drive the mechanical lock body 500 to unlock. The linear drive structure may be an air cylinder or a combined structure of a motor and a rack and pinion. The corresponding bolt control member is actuated by the transmission part, so as to control the contraction of the bolt to achieve the unlocking.

It can be understood that, the unlocking device may comprise a housing, in which the control module 200 is arranged, wherein the knob structure can be protruded from one side of the housing, and the connecting portion 223 or the portion of the transmission rod, which is connected to the bolt control member, is protruded on another side of the housing. Arranging the control module 200 in the housing is beneficial to reduce the adhesion of dust and other pollutants to the control module 200 which may affect its working performance.

It can be understood that, the unlocking device further includes a mounting structure 400, and the signal generating module 100 is fixedly arranged on the mounting structure 400. The mounting structure 400 includes a mounting portion 410 and a fixing portion 420 connected to the mounting portion 410, and the signal generating module 100 is disposed on the fixing portion 420. The mounting portion 410 may be formed in a ring shape. In some embodiments, the mounting portion 410 is sleeved on the door handle 600. By providing the mounting structure 400, the mounting portion 410 of the mounting structure 400 is sleeved on the door handle 600, and the mounting structure 400 is mounted on the door body 700. Since the mounting structure 400 is hung on the door by the mounting portion 410, and the mounting structure 400 usually has a surface are larger than that of a single signal generating module 100, the contact area between the mounting structure 400 and the door 700 will be larger than that of the signal generating module 100 alone. In this way, the installation structure 400 can be firmly installed. Compared with directly installing the signal generating module 100 on the door 700, as the material of the door 700 is unchangeable, the signal generating module 100 fixedly arranged on the mounting structure 400 will not fall easily.

It can be understood that, the signal generation module 100 includes at least one of the followings: a fingerprint input unit, a keyboard input unit, an iris recognition unit, a vein recognition unit, and a face recognition unit. The signal generation module 100 may be configured as one or a combination of two or more of the follows: a keyboard input unit, an iris recognition unit, a vein recognition unit, a face recognition unit, a radio frequency recognition unit, a NFC recognition unit, a IC card recognition unit, a magnetic card recognition unit, a Bluetooth unlock signal recognition unit, a remote network unlock signal identification unit, so that the user can unlock the door lock in a variety of ways, the convenience of unlocking is improved for users. It can be understood that, the signal generation module 100 mentioned in the embodiment of the present disclosure includes but is not limited to the above, any means can be used as long as it can generate an unlock signal.

It can be understood that, the communication between the signal generation module 100 and the main control unit 210 may be implemented in the following ways: the signal generating module 100 and the main control unit 210 are communicated over a signal line, which is beneficial to the stability of signal transmission and reduces external Influence of interference sources; and/or the signal generating module 100 and the main control unit 210 are respectively provided with wireless signal transceivers, and the wireless signal transceivers are communicatively connected, which can reduce the corresponding wiring and reduce the damage to the door 700.

Hereinafter, the unlocking device according to the embodiment of the present disclosure will be described in detail by a specific embodiment with reference to FIGS. 1 to 5. It should be understood that, the following description is only an exemplary description, rather than a specific limitation to the present disclosure.

The embodiment of the present disclosure provides an unlocking device, including: a signal generating module 100, which is configured to generate an unlocking signal; and a control module 200, which includes a main control unit 210 and a driving unit 220. The main control unit 210 is communicated with the signal generating module 100, the driving unit 220 is connected to the mechanical lock body 500, and the main control unit 210 is configured to receive the unlocking signal generated by the signal generating module 100, and control the driving unit 220 to drive the mechanical lock body 500 to unlock according to the unlocking signal received.

The driving unit 220 includes a rotating drive structure 221 and a rotating shaft 222. One end of the rotating shaft 222 is provided with a connecting portion 223 matching a bolt control member of the mechanical lock. The connecting portion 223 is connected to the bolt control member of the mechanical lock. The driving structure 221 is constructed to drive the rotating shaft 222 to rotate, thereby to drive the mechanical lock body 500 to unlock. The rotating drive structure 221 includes a motor and a gear assembly. The rotating shaft 222 is provided with a gear portion. An output shaft of the motor is connected to a gear in the gear assembly close to it. The gear portion meshes with a gear in the gear assembly close to it. The connecting portion 223 is detachably connected to the rotating shaft 222. A knob structure 300 is provided at another end of the rotating shaft 222, and the knob structure 300 is constructed to drive the rotating shaft 222 to rotate when the knob structure 300 is rotated.

The unlocking device further includes a mounting structure 400, and the signal generating module 100 is fixedly arranged on the mounting structure 400. The mounting structure 400 includes a mounting portion 410 and a fixing portion 420 connected to the mounting portion 410, and the signal generating module 100 is disposed on the fixing portion 420. The signal generation module 100 includes at least one of the followings: a fingerprint input unit, a keyboard input unit, an iris recognition unit, a vein recognition unit, a face recognition unit, a radio frequency recognition unit, a NFC recognition unit, a IC card recognition unit, a magnetic card recognition unit, a Bluetooth Unlock signal recognition unit, a remote network unlock signal recognition unit. The communication connection between the signal generation module 100 and the main control unit 210 is in one of the following ways: the signal generation module 100 and the main control unit 210 are communicated through a signal line; the signal generation module 100 and the main control unit 210 are respectively provided with wireless signal transceivers, the wireless signal transceivers are wirelessly communicated.

According to the unlocking device of the embodiment of the present disclosure, through such a configuration described above, at least one of the following effects can be achieved. The unlocking device can be attached onto the original mechanical lock. The unlocking device includes a signal generating module 100 and a control module 200. The control module 200 includes a main control unit 210 and a driving unit 220. The signal generating module 100 is configured to generate an unlocking signal, the driving unit 220 is connected to the mechanical lock body 500, and the main control unit 210 is configured to receive the unlocking signal generated by the signal generating module 100, and control the driving unit 220 to drive the mechanical lock body 500 to unlock according to the unlocking signal received. Through the above arrangement, it is possible to directly attach a signal-controlled unlocking device onto the mechanical lock without disassembling the mechanical door lock, thereby effectively reducing the cost of switching from a mechanical door lock to a signal-controlled door lock, and the original mechanical lock body 500 can be continuedly used and thus the waste of door lock materials is reduced.

Although the embodiments of the present disclosure have been illustrated and described, a person of ordinary skill in the art can understand that various changes, modifications, replacements and transformations can be made to these embodiments without departing from the principle and purpose of the present disclosure. The scope of the present disclosure is defined by the claims and their equivalents.

1. An unlocking device for controlling unlocking of a mechanical lock body, comprising:
a signal generating module, configured to generate an unlock signal; and
a control module, comprising:
a main control unit, communicated with the signal generation module, and
a drive unit, connected with the mechanical lock body; and
wherein, the main control unit is configured to receive the unlocking signal generated by the signal generating module, and control the drive unit to drive the mechanical lock body to unlock according to the unlocking signal received.

2. The unlocking device of claim 1, wherein the drive unit comprises:
a rotating drive structure, and
a rotating shaft, at one end thereof connected to a bolt control member of the mechanical lock body, and
wherein the rotation driving structure is constructed to drive the rotation shaft to rotate, thereby driving the mechanical lock body to unlock.

3. The unlocking device of claim 2, wherein the rotating shaft is provided with a knob structure at another end thereof, and the knob structure is constructed to drive the rotating shaft to rotate while the knob structure is rotated.

4. The unlocking device of claim 2, wherein the rotating drive structure comprises a motor and a gear assembly, and the rotating shaft is provided with a gear portion, wherein the motor is in transmission connection with the gear portion by the gear assembly, for driving the rotation shaft to rotate.

5. The unlocking device of claim 2, wherein the rotating shaft is provided with a connecting portion at one end thereof, through which the rotating shaft is connected to the bolt control member of the mechanical lock.

6. The unlocking device of claim 4, wherein the rotating shaft and the connecting portion are integrally formed.

7. The unlocking device of claim 4, wherein the connecting portion is detachably connected to the rotating shaft.

8. The unlocking device of claim 1, further comprising a mounting structure, on which the signal generating module is fixedly arranged.

9. The unlocking device of claim 8, wherein the mounting structure is provided with a mounting portion formed in a ring shape, for fixedly mounting the installation structure on a door handle.

10. The unlocking device of claim 9, wherein the mounting structure comprises a fixing portion connected to the mounting portion, and the signal generating module is arranged on the fixed part.

11. The unlocking device of claim 1, wherein the signal generating module comprises at least one of: a fingerprint input unit, a keyboard input unit, an iris recognition unit, a vein recognition unit, a face recognition unit, a radio frequency identification unit, a NFC identification unit, a IC card identification unit, a magnetic card identification unit, a Bluetooth unlock signal identification unit, and a remote network unlock signal identification unit.

12. The unlocking device of claim 1, wherein a communication connection between the signal generating module and the main control unit is through one of:
the signal generating module and the main control unit are in communication connection through a signal line; and
the signal generating module and the main control unit are respectively provided with a wireless signal transceiver, and the wireless signal transceivers are communicatively connected.

13. The unlocking device of claim 1, wherein the drive unit comprises:
a linear drive structure, and
a transmission member, at one end thereof connected to the bolt control member of the mechanical lock body, and
wherein the linear drive structure is configured to drive the transmission member to move, thereby driving the mechanical lock body to unlock.

14. A door lock, comprising:
a mechanical lock body;
an unlocking device according to claim 1, wherein the control module of the unlocking device is arranged on one side of the mechanical lock body, and the signal module of the unlocking device is arranged on another side of the mechanical lock body; and
a door handle, arranged on the same side as the signal generating module, wherein a lock body driving member on the door handle is connected to the corresponding bolt control member of the mechanical lock body, and the door handle drives a bolt of the mechanical lock body to perform a telescopic movement when the door handle is rotated.
